(19) United States
(12) Patent Application Publication
(10) Pub. No.: US 2007/0126138 A1
(43) Pub. Date: Jun. 7, 2007

(54) METHOD AND APPARATUS FOR MAKING A PART

(75) Inventors: David J. Dooley, Troy, MI (US); Todd L. Depue, Brighton, MI (US); Glenn A. Cowelchuk, Chesterfield, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 11/275,067

(22) Filed: Dec. 7, 2005

(51) Int. Cl. B29C 44/12

(52) U.S. Cl. 264/46.4; 425/542; 425/577

(57) ABSTRACT

A method of making a part includes introducing expandable material into a cavity of a mold containing a substrate, the mold including at least one projection extending into the cavity. The method further includes retracting the at least one projection to allow the expandable material to expand in the cavity, such that the expandable material forms an expanded material layer on the substrate.

### BACKGROUND OF THE INVENTION

1. Field of the Invention

The invention relates to a method and apparatus for making a part having a substrate and an expanded material layer attached to the substrate.

2. Background Art

An arm rest for use with a motor vehicle may include a substrate and an expanded foam layer attached to the substrate. A prior method of making such an arm rest includes injecting foamable plastic material and a blowing agent into a pressurized mold cavity having the substrate positioned therein, in order to form the foam layer on the substrate. The mold cavity is pressurized in order to form a suitable appearance surface on the foam layer. Because the mold cavity is pressurized, however, expansion of the plastic material is restricted. As a result, the softness of the foam layer is limited.

### SUMMARY OF THE INVENTION

Under the invention, a method of making a part is provided. The method includes introducing expandable material into a cavity of a mold containing a substrate, the mold including at least one projection extending into the cavity. The method further includes retracting the at least one projection to allow the expandable material to expand in the cavity, such that the expandable material forms an expanded material layer on the substrate.

Further under the invention, an apparatus for making a part includes a mold having a cavity configured to receive a substrate having an aperture. The mold includes a moveable projection that is configured to extend through the aperture of the substrate and into the cavity. The apparatus further includes an expandable material introduction device for introducing expandable material into the cavity. Moreover, the mold is configured to retract the projection after the expandable material has been introduced into the cavity, to thereby provide space for expansion of the expandable material.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a schematic cross-sectional view of a part according to the invention, wherein the part includes a substrate and an expanded material layer attached to the substrate;

FIG. 2 is a schematic cross-sectional view of a mold for making the substrate, wherein the mold includes first and second mold portions that define a first mold cavity;

FIG. 3 is a schematic cross-sectional view of the mold showing a third mold section engaged with the first mold section to define a second mold cavity, and further showing projections of the mold extending into the second mold cavity;

FIG. 4 is a schematic cross-sectional view of the first and third mold sections and showing expandable material injected into the second mold cavity; and

FIG. 5 is a schematic cross-sectional view of the first and third mold sections and showing the projections retracted out of the second mold cavity.

### DETAILED DESCRIPTION

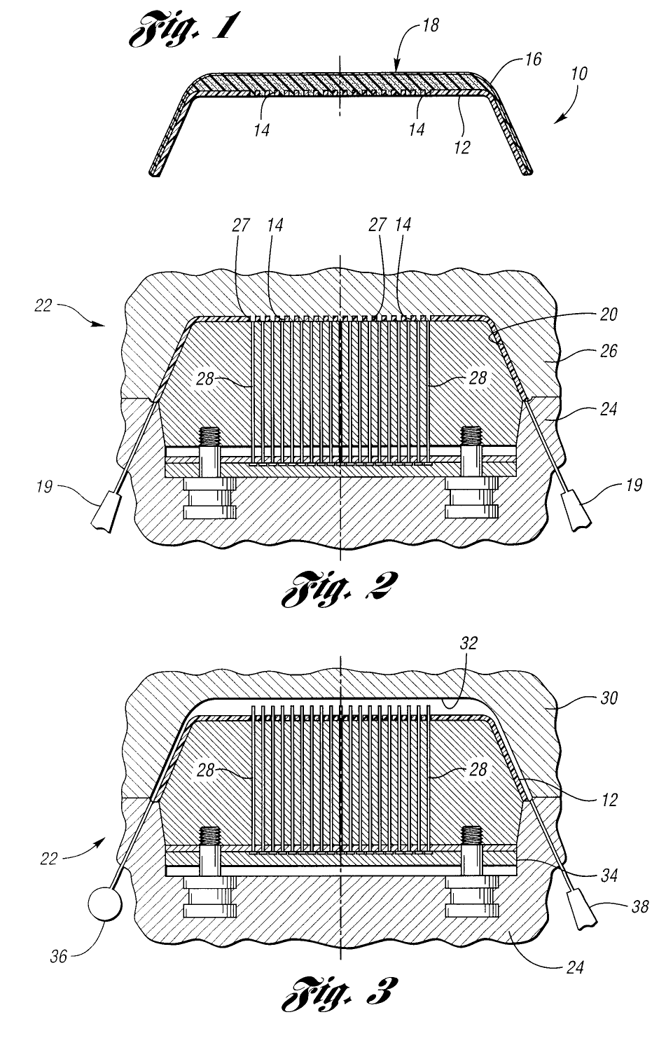

FIG. 1 shows a part 10 according to the invention for use with a motor vehicle (not shown). For example, the part 10 may be an interior trim part, such as an arm rest, console, instrument panel, door panel, etc. As shown in FIG. 1, the part 10 includes a substrate 12 having multiple apertures 14 extending therethrough, and an expanded material layer 16 attached to the substrate 12.

The substrate 12 may be configured to support the expanded material layer 16, and may be made of any suitable material. For example, the substrate 12 may be made of injection molded or compression molded plastic, such as non-expanded polypropylene, polyethylene terephthalate, urethane, or acrylonitrile butadiene styrene.

The expanded material layer 16 may be formed such that a substantial portion or all of the expanded material layer 16 has a relatively low density. Moreover, the expanded material layer 16 may be formed as a resilient layer that is configured to provide a soft feel to the part 10. The expanded material layer 16 may also define an appearance surface or “A” surface 18 of the part 10. Furthermore, the expanded material layer 16 may be made of any suitable material, such as expanded polypropylene, polyethylene, polycarbonate, polyvinyl chloride, or thermoplastic elastomer.

Referring to FIGS. 2-5, an exemplary method of making the part 10 will now be described in detail. First, the substrate 12 may be made in any suitable manner. Referring to FIG. 2 for example, one or more first material introduction devices 19 may inject or otherwise introduce plastic material into a first mold cavity 20 of a mold 22. In the embodiment shown in FIG. 2, the mold 22 includes first and second mold portions 24 and 26, respectively, that cooperate to define the first mold cavity 20. The second mold portion 26 also has multiple projections 27, such as cylindrical projections, for forming the apertures 14 in the substrate 12. The mold 22 further includes multiple projections 28, such as cylindrical pins, that are moveable with respect to the first mold portion 24.

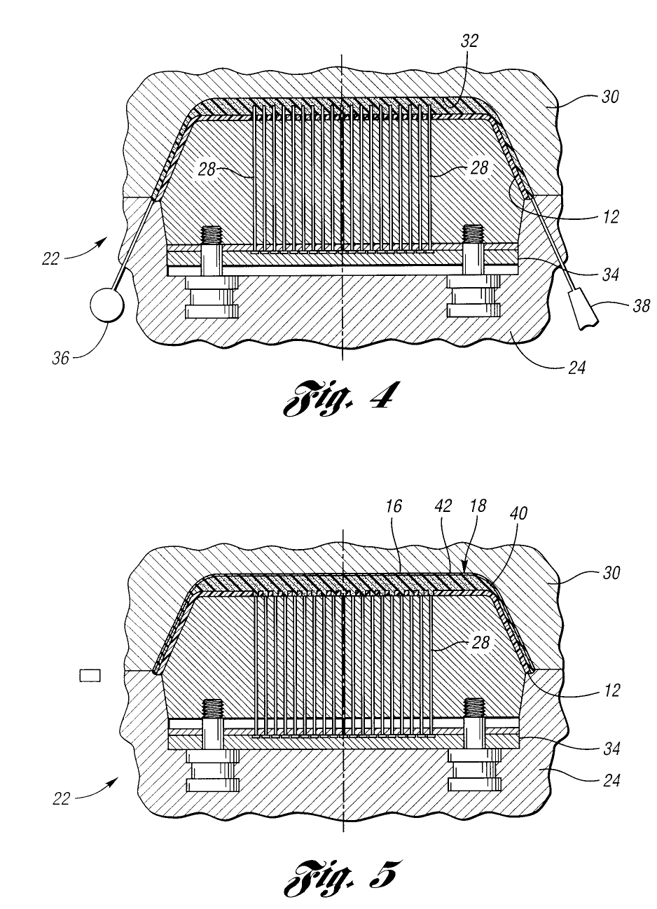

After the substrate 12 has been molded, the mold 22 may be opened, such as by moving the second mold portion 26 with respect to the first mold portion 24. Next, referring to FIG. 3, a third mold portion 30 may be brought into contact with the first mold portion 24 to define a second mold cavity 32. The projections 28 may also be raised or otherwise moved so that the projections 28 extend into the second mold cavity 32. For example, the projections 28 may be raised by a slide member 34 that supports the projections 28.

A pressure source 36 may also be used to supply any suitable fluid, such as air, nitrogen, or other inert gas, to the second mold cavity 32 in order to pressurize the second mold cavity 32. While the second mold cavity 32 may be pressurized to any suitable pressure, in one embodiment, the second cavity 32 is pressurized to a pressure in the range of 50 to 2000 pounds per square inch.

Referring to FIG. 4, the method then involves introducing expandable material into the second mold cavity 32. For example, one or more second material introduction devices 38 may be used to inject or otherwise introduce a mixture of expandable plastic material and a blowing agent into the second mold cavity 32. Suitable blowing agents are available from PolyOne Corporation of Cleveland, Ohio, and A. Schulman Inc. of Akron, Ohio, for example.

After the second mold cavity 32 has been sufficiently filled, the pressure may be reduced in the second mold cavity 32 and the projections 28 may be retracted, as shown in FIG. 5, thereby providing additional space for expansion of the expandable material. For example, after the mold cavity 32 has been filled greater than approximately 90%, one or more vent passages (not shown) may be used to vent fluid introduced by the pressure source 36. The expandable material may then expand to form the expanded material layer 16.

With such a process, the expanded material layer 16 may be formed with a low density main portion 40, such as a low density foam portion, and a more dense skin portion 42 that defines the “A” surface 18 of the part 10. For example, the main portion 40 may have a specific gravity in the range of 0.4 to 1.2, and the skin portion 42 may have a specific gravity in the range of 0.8 to 1.5. Thus, if the expanded material layer 16 is formed as a resilient layer, the expanded material layer 16 may provide a soft feel for the part 10, while also providing a high quality “A” surface 18.

More specifically, by pressurizing the second mold cavity 32 during introduction of the expandable material, expansion of gas bubbles may be inhibited until after sufficient formation of the skin portion 42. As a result, surface imperfections, such as bubbles or other surface splay, on the “A” surface 18 may be minimized or eliminated.

The above method may also be modified in any suitable manner. For example, the projections 28 of the mold 22 may be used to form the apertures 14 of the substrate 12. As another example, the substrate 12 may be formed in a separate mold (not shown). Next, the substrate 12 may be transferred to the first mold portion 24, and the method may then continue as described above in detail.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of making a part, the method comprising:
introducing expandable material into a cavity of a mold containing a substrate, the mold including at least one projection extending into the cavity; and
retracting the at least one projection to allow the expandable material to expand in the cavity, such that the expandable material forms an expanded material layer on the substrate.

2. The method of claim 1 wherein each projection extends through an aperture in the substrate prior to the retracting step.

3. The method of claim 1 further comprising pressurizing the cavity, wherein the pressurizing step commences prior to the introducing step.

4. The method of claim 3 further comprising reducing pressure in the cavity prior to the retracting step.

5. The method of claim 1 wherein the at least one projection includes multiple projections that are configured to extend through multiple apertures in the substrate and into the cavity prior to the retracting step, and wherein the retracting step includes retracting the projections to allow the expandable material to expand in the cavity.

6. The method of claim 5 further comprising pressuring the cavity prior to the introducing step, and reducing pressure in the cavity prior to the retracting step.

7. The method of claim 1 wherein the expanded material layer is a resilient layer.

8. The method of claim 7 wherein the expanded material layer comprises foam.

9. The method of claim 1 further comprising forming the substrate using at least a portion of the mold such that the substrate includes multiple apertures, wherein the at least one projection includes multiple projections that extend through the apertures of the substrate and into the cavity prior to the retracting step, and wherein the retracting step includes retracting the projections to allow the expandable material to expand in the cavity.

10. The method of claim 1 wherein the introducing step comprises introducing a blowing agent into the cavity.

11. A method of making a part, the method comprising:
pressurizing a cavity of a mold having a substrate positioned therein, the mold including multiple projections that extend through multiple apertures of the substrate and into the cavity;
introducing expandable plastic material into the cavity;
reducing pressure in the cavity after the introducing step; and
retracting the projections to allow the plastic material to expand in the cavity, such that the plastic material forms a resilient foam layer on the substrate, the resilient layer providing an appearance surface of the part.

12. An apparatus for making a part, the apparatus comprising:
a mold having a cavity configured to receive a substrate having an aperture, the mold including a moveable projection that is configured to extend through the aperture of the substrate and into the cavity; and
an expandable material introduction device for introducing expandable material into the cavity;
wherein the mold is configured to retract the projection after the expandable material has been introduced into the cavity, to thereby provide space for expansion of the expandable material.

13. The apparatus of claim 12 wherein the mold includes multiple moveable projections that are configured to extend through multiple apertures of the substrate and into the cavity, and wherein the mold is configured to retract the projections after the expandable material has been introduced into the cavity.

14. The apparatus of claim 12 further comprising a pressure source for pressurizing the cavity.
